(19) United States
(12) Patent Application Publication
(10) Pub. No.: US 2002/0185510 A1
(43) Pub. Date: Dec. 12, 2002

(54) Apparatus and associated method for hanging auxiliary rolled sheet material

(76) Inventor: William Holsclaw, Frankfort, IN (US)

Correspondence Address: BARNES & THORNBURG, 11 SOUTH MERIDIAN, INDIANAPOLIS, IN, 46204

(21) Appl. No.: 10/212,581

(22) Filed: Aug. 5, 2002

Related U.S. Application Data
(63) Continuation of application No. 09/639,603, filed on Aug. 15, 2000.

(51) Int. Cl. B26F 3/00

(52) U.S. Cl. 225/2; 225/42

(57) ABSTRACT

An apparatus including a frame which has a first support having secured thereto a first hook member which has a first opening and a second hook member which has a second opening. The apparatus also includes a second support positioned adjacent to the first support. The second support has secured thereto a third hook member which has a third opening and a fourth hook member which has a fourth opening. When the frame is positioned in a first orientation the first opening of the first hook member and third opening of the third hook member are positioned to receive a first spindle and the second hook opening of the second hook member and the fourth hook opening of the fourth hook member are positioned to receive an axle for supporting the auxiliary rolled sheet material. When the frame is positioned in a second orientation the second opening of the second hook member and fourth opening of the fourth hook member are positioned to receive the second spindle and the first opening of the first hook member and the third opening of the third hook member are positioned to receive the axle for supporting the auxiliary rolled sheet material. An associated method is also disclosed.

This Application is a Continuation Application under 35 U.S.C. §120 of U.S. application Ser. No. 09/639,603 filed Aug. 15, 2000 and incorporated by reference herein.

### BACKGROUND OF THE INVENTION

The present invention generally relates to an apparatus and method for hanging an auxiliary rolled sheet material, and more particularly relates to an apparatus and method for hanging an auxiliary roiled sheet material on a first spindle which is attached to an exterior surface of a first wall portion and a second spindle which is positioned within a recess defined in a second wall portion.

Holders have been designed for supporting, displaying, and dispensing auxiliary rolled sheet material, such as toilet paper. For example, one approach includes an ornamental design for a single, spare roll of toilet paper. In particular, a piece of material is placed around a spare roll of toilet paper, which is then tied to the support brackets which extend from a wall portion. This design does provide a spare roll of toilet paper in plain view for a person to use should they encounter a primary roll which is about to run out, however a draw back to this approach is that the spare roll must be removed from this apparatus in order to be accessible for use.

Another approach to providing an auxiliary rolled sheet material utilizes a bracket assembly for supporting a spare tissue roll on a spindle recessed into a wall. This approach also provides a spare roll for use, however, it requires several tools for attaching the bracket to the primary holder.

Furthermore, heretofore, no single device allows an auxiliary rolled sheet material to be attached, without the use of any tools, to either a spindle which is recessed in a wall portion or a spindle which extends outwardly from a wall surface.

In addition, the spindles of the aforementioned devices are typically spring loaded and thus very difficult to use by a person who has decreased hand dexterity. Moreover, these spindles are configured such that the auxiliary rolled sheet material tends to unroll very easily which can cause an unsightly mess and an inconvenience.

Therefore there is a need for a method and apparatus for hanging an auxiliary rolled sheet material which addresses one or more of the above described problems.

### SUMMARY OF THE INVENTION

In accordance with one embodiment of the present invention, there is provided an apparatus for hanging an auxiliary rolled sheet material from (i) a first spindle which is attached to an exterior surface of a first wall such that the first spindle is spaced outwardly from the exterior surface by a distance D₁ or (ii) a second spindle which is positioned within a recess defined in a second wall.

The apparatus includes a frame which has a first support having secured thereto a first hook member which has a first opening and a second hook member which has a second opening. The first hook member is laterally spaced apart from the second hook member and positioned relative to the second hook member such that the first opening is in an opposing relationship with the second opening. The apparatus also includes a second support positioned adjacent to the first support. The second support has secured thereto a third hook member which has a third opening and a fourth hook member which has a fourth opening. The third hook member is laterally spaced apart from the fourth hook member and positioned relative to the fourth hook member such that the third opening is in an opposing relationship with the fourth opening. When the frame is positioned in a first orientation the first opening of the first hook member and the third opening of the third hook member are positioned to receive the first spindle and the second opening of the second hook member and the fourth opening of the fourth hook member are positioned to receive an axle for supporting the auxiliary roiled sheet material. When the frame is positioned in a second orientation the second opening of the second hook member and the fourth opening of the fourth hook member are positioned to receive the second spindle and the first opening of the first hook member and the third opening of the third hook member are positioned to receive the axle for supporting the auxiliary rolled sheet material.

Pursuant to another embodiment of the present invention, there is provided an apparatus for hanging an auxiliary rolled sheet material from (i) a first spindle which is attached to an exterior surface of a first wall such that the spindle is spaced outwardly from the exterior surface by a distance D₁ or (ii) a second spindle which is positioned within a recess defined in a second wall. The apparatus includes a frame which has a first support having secured thereto a first hook member which has a first opening and a second hook member which has a second opening, the first hook member is laterally spaced apart from the second hook member and positioned relative to the second hook member such that the first opening is in an opposing relationship with the second opening. The apparatus also includes a second support positioned adjacent to the first support, the second support has secured thereto a third hook member which has a third opening and a fourth hook member which has a fourth opening, the third hook member is laterally spaced apart from the fourth hook member and positioned relative to the fourth hook member such that the third opening is in an opposing relationship with the fourth opening. The apparatus further includes an axle which has a transverse cross-section which has the shape of a parallelogram and has a unitary construction. When the frame is positioned in a first orientation, the first opening of the first hook member and the third opening of the third hook member are positioned to receive the first spindle and the second opening of the second hook member and the fourth opening of the fourth hook member are positioned to receive the axle for supporting the auxiliary rolled sheet material. When the frame is positioned in a second orientation, the second opening of the second hook member and the fourth opening of the fourth hook member are positioned to receive the second spindle and the first opening of the first hook member and the third opening of the third hook member are positioned to receive the axle for supporting the auxiliary rolled sheet material. According to yet another embodiment of the present invention, there is provided a method for hanging an auxiliary rolled sheet material from (i) a first spindle which is attached to an exterior surface of a first wall such that the first spindle is spaced outwardly from the exterior surface by a distance D₁ or (ii) a second spindle which is positioned within a recess defined in a second wall. The method includes the step of positioning a frame in a first orientation, the frame including (i) a first support having secured thereto a first hook member which has a first opening and a second hook member which has a second opening, the first hook member being positioned relative to the second hook member such that the first opening is in an opposing relationship with the second opening and (ii) a second support positioned adjacent to the first support, the second support having secured thereto a third hook member which has a third opening and a fourth hook member which has a fourth opening, the third hook member being positioned relative to the fourth hook member such that the third opening is in an opposing relationship with the fourth opening. The method also includes the step of locating the frame relative to the first spindle so that the first spindle is positioned within the first hook member and the third hook member. The method further includes the step of positioning the frame in a second orientation which is different from the first orientation. The method also includes the step of locating the frame relative to the second spindle so that the second spindle is positioned within the second hook member and the fourth hook member.

It is therefore an object of the present invention to provide a new and useful apparatus for hanging an auxiliary rolled sheet material.

It is therefore also an object of the present invention to provide a new and useful method for hanging an auxiliary rolled sheet material.

It is another object of the present invention to provide an improved apparatus for hanging an auxiliary rolled sheet material.

It is still another object of the present invention to provide an improved method for hanging an auxiliary rolled sheet material.

It is yet another object of the present invention to provide an apparatus for hanging an auxiliary rolled sheet material which is easily utilized by a person with decreased hand dexterity.

It is still another object of the invention to provide an apparatus for hanging an auxiliary rolled sheet material which prohibits undesirable unrolling of the rolled sheet material.

The above and other objects, features, and advantages of the present invention will become apparent from the following description and attached drawings.

### BRIEF DESCRIPTION OF THE DRAWINGS

FIG. 1 is a perspective view of an apparatus for hanging an auxiliary rolled sheet material which incorporates the features of the present invention therein (note that the axle of the apparatus is shown removed from the hook members);

FIG. 2 is a perspective view of the apparatus of FIG. 1 shown in the first orientation and hanging from a spindle which is attached to an exterior surface of a wall such that the spindle is spaced outwardly from the exterior surface by a distance D₁;

FIG. 3 is a perspective view of the apparatus of FIG. 1 shown in the second orientation and hanging from a spindle which is positioned within a recess defined in a wall; and

FIG. 4 is a front elevational view of a human head with the facial area thereof being contacted with a removable sheet portion of the auxiliary rolled sheet material of FIG. 2, note that the removable sheet portion is being grasped by a human hand for clarity of description.

### DETAILED DESCRIPTION OF THE PREFERRED EMBODIMENT

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims.

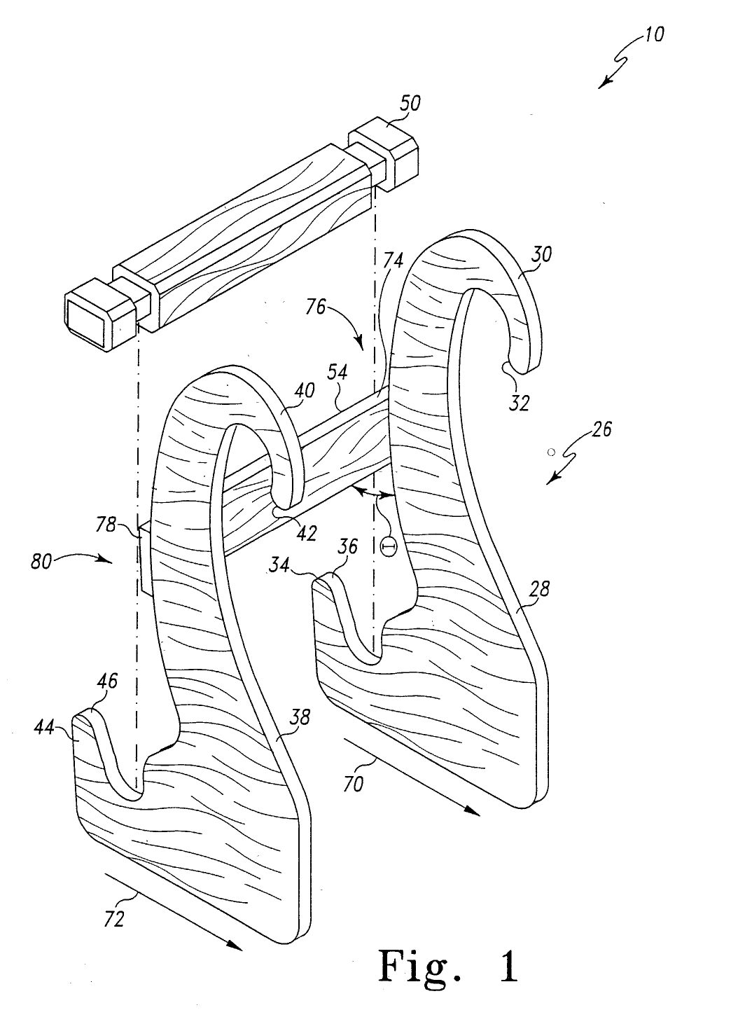

Referring to FIGS. 1-3, there is shown an apparatus 10 for hanging an auxiliary rolled sheet material 12 which incorporates the features of the present invention therein. The apparatus 10 includes a frame 26 which includes (i) a first support 28 having secured thereto a first hook member 30 which has a first opening 32 and a second hook member 34 which has a second opening 36 and (ii) a second support 38 positioned adjacent to the first support 28, the second support 38 having secured thereto a third hook member 40 which has a third opening 42 and a fourth hook member 44 which has a fourth opening 46.

Apparatus 10 also includes a cross bar 54 which extends between and is secured to first support 28 and second support 38. Cross bar 54 is secured to first support 28 and second support 38 such that a substantially 90° θ angle is defined between cross bar 54 and first support 28. Cross bar 54 is attached to second support 38 in a substantially identical way as described above for first support 28. Cross bar 54 is also secured to first support 28 such that a first end 74 of cross bar 54 is attached to first support 28 at a first location 76 which is interposed between first hook member 30 and second hook member 34. Cross bar 54 is also secured to second support 38 such that a second end 78 of cross bar 54 is attached to second support 38 at a second location 80 which is interposed between third hook member 40 and fourth hook member 44.

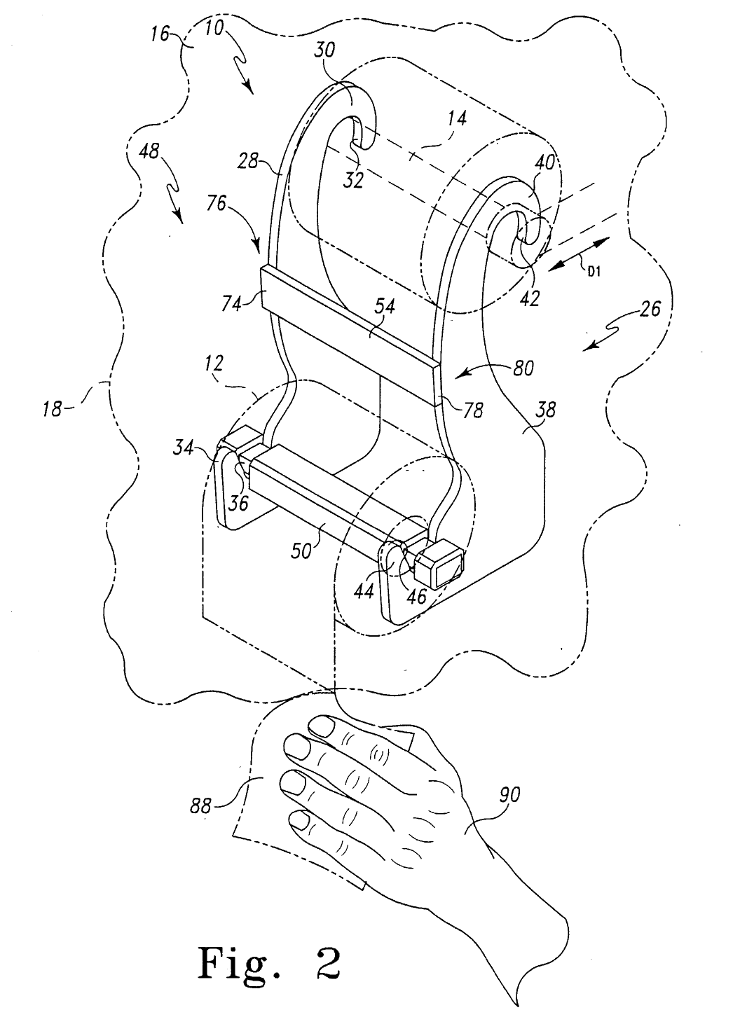

As shown in FIG. 2, apparatus 10 can be utilized for hanging auxiliary rolled sheet material 12 from spindle 14 attached to a surface 16 of wall 18 such that spindle 14 is spaced outwardly from exterior surface 16 by a distance of D₁. When utilized with an exterior spindle 14, apparatus 10 is positioned in a first orientation 48, so that first opening 32 of first hook member 30 and third opening 42 of third hook member 40 are positioned to receive spindle 14 and second opening 36 of second hook member 34 and fourth opening 46 of fourth hook member 44 are positioned to received axle 50 for supporting auxiliary rolled sheet material 12.

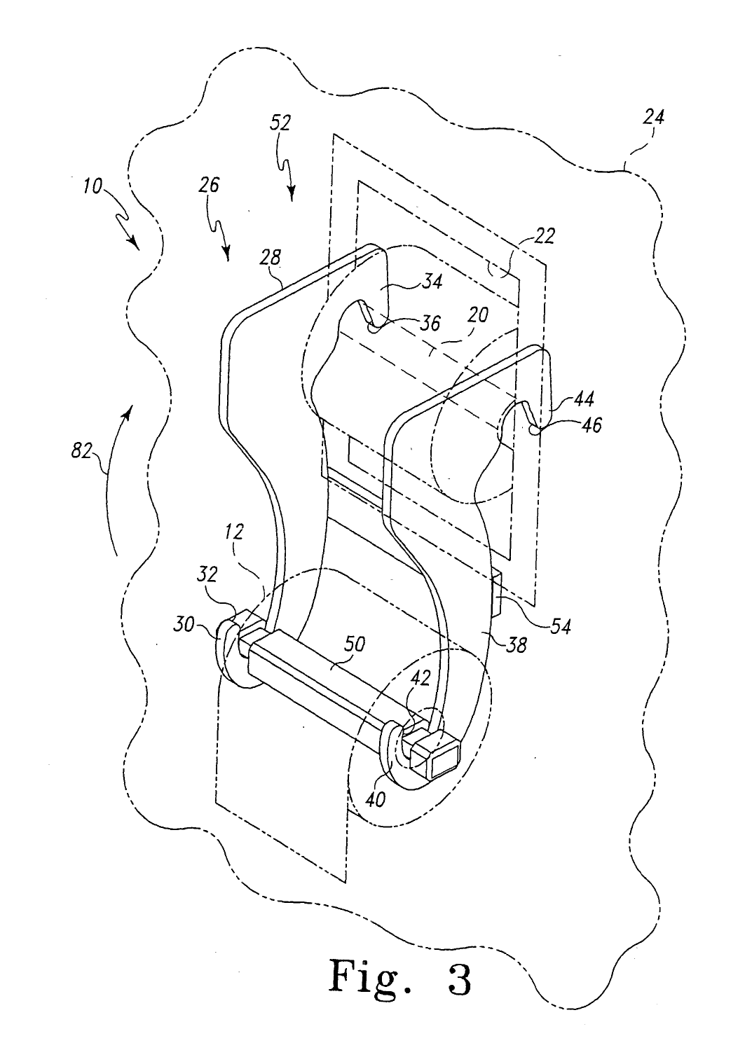

On the other hand, as shown in FIG. 3, apparatus 10 can be utilized for hanging auxiliary rolled sheet material 12 from spindle 20 positioned within a recess 22 defined in a wall 24. When utilized with a recessed spindle 20, apparatus 10 is positioned in a second orientation 52 such that second opening 36 of second hook member 34 and fourth opening 46 of fourth hook member 44 are positioned to receive spindle 20 and first opening 32 of first hook member 30 and third opening 42 of third hook member 40 are positioned to receive axle 50 for supporting auxiliary rolled sheet material 12.

As shown more clearly in FIG. 1, in order for the reversibility of apparatus 10 to be achieved it must be constructed so that (A) first hook member 30 is (i) laterally spaced apart from second hook member 34 in the direction indicated by arrow 70 and (ii) positioned relative to second hook member 34 such that first opening 32 is in an opposing relationship with second opening 36 and (B) third hook member 40 is (i) laterally spaced apart from fourth hook member 44 in the direction indicated by 72 and (ii) positioned relative to fourth hook member 44 such that third opening 42 is in an opposing relationship with fourth opening 46. This unique construction makes it possible to simply remove the device from one location with a recessed spindle 20, rotate frame 26 180° in the direction indicated by arrow 82 (see FIG. 3) and hang it from an exterior spindle 14 without the complication of brackets or the use of tools.

This apparatus 10 further includes an axle 50 which has a transverse cross-section having the shape of a parallelogram. Axle 50 also has a unitary construction, Axle 50 is shaped in such a way so as to avoid unintentional or undesirable unrolling of auxiliary rolled sheet material 12. The significance of the unitary construction of axle 50 if for ease of use. For example, this unitary axle 50 does not require the dexterity needed to operate a spindle which longitudinally compresses for removing and replacing a roll of toilet paper.

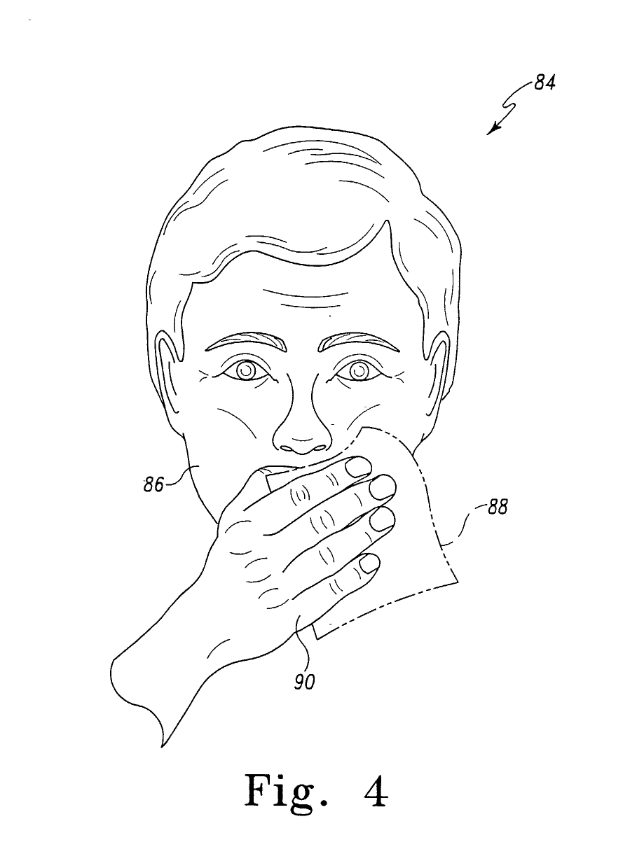

Referring now to FIG. 4, there is shown a human head 84 with the facial area 86 thereof being contacted with a removable sheet portion 88 of auxiliary rolled sheet material 12. Removable sheet portion 88 is being grasped by a human hand 90. As illustrates by FIGS. 2 and 4, during use of apparatus 10 a user can grasp a removable sheet portion 88 of auxiliary rolled sheet material 12 with hand 90 and remove or detach removable sheet portion 88 from auxiliary rolled sheet material 12. Once removable sheet portion 88 is removed from auxiliary rolled sheet material 12, the user can contact a body portion of the user with removable sheet portion 88 for various well known purposes. For example, the user may contact facial area 86 of human head 84 with removal sheet portion 88.

While the invention has been illustrated and described in detail in the drawings and foregoing description, such illustration and description is to be considered as exemplary and not restrictive in character, it being understood that only the preferred embodiments have been shown and described and that all changes and modifications that come within the spirit of the invention are desired to be protected.

What is claimed is:

1. An apparatus for hanging an auxiliary rolled sheet material from (i) a first spindle which is attached to an exterior surface of a first wall such that said first spindle is spaced outwardly from said exterior surface by a distance D₁ or (ii) a second spindle which is positioned within a recess defined in a second wall, comprising:
a frame which includes (i) a first support having secured thereto a first hook member which has a first opening and a second hook member which has a second opening, said first hook member being (A) laterally spaced apart from said second hook member along a first axis which intersects a longitudinal axis of said first support and (B) positioned relative to said second hook member such that said first opening is in an opposing relationship with said second opening, (ii) a second support positioned adjacent to said first support, said second support having secured thereto a third hook member which has a third opening and a fourth hook member which has a fourth opening, said third hook member being (A) laterally spaced apart from said fourth hook member along a second axis which intersects a longitudinal axis of said second support and (B) positioned relative to said fourth hook member such that said third opening is in an opposing relationship with said fourth opening, and (iii) a cross bar which extends between said first support and said second support, said cross bar being secured to said first support and said second support,
wherein when (i) said frame is positioned in a first orientation said first opening of said first hook member and said third opening of said third hook member are positioned to receive said First spindle and said second opening of said second hook member and said fourth opening of said fourth hook member are positioned to receive an axle for supporting said auxiliary rolled sheet material and (ii) when said frame is positioned in a second orientation said second opening of said second hook member and said fourth opening of said fourth hook member are positioned to receive said second spindle and said first opening of said first hook member and said third opening of said third hook member are positioned to receive said axle for supporting said auxiliary rolled sheet material.

2. The apparatus of claim 1, wherein:
said cross bar is secured to said first support such that a substantially 90° angle is defined between said cross bar and said first support.

3. The apparatus of claim 1, wherein:
a first end of said cross bar is attached to said first support at a first location which is interposed between said first hook member and said second hook member.

4. The apparatus of claim 3, wherein:
a second end of said cross bar is attached to said second support at a second location which is interposed between said third hook member and said fourth hook member.

5. The apparatus of claim 1 wherein:
said axle has a transverse cross-section which has a shape of a parallelogram.

6. The apparatus of claim 5, wherein:
said parallelogram is a rectangle.

7. The apparatus of claim 1, wherein:
said axle has a unitary construction.

8. An apparatus for hanging an auxiliary rolled sheet material from (i) a first spindle which is attached to an exterior surface of a first wall such that said first spindle is spaced outwardly from said exterior surface by a distance D₁ or (ii) a second spindle which is positioned within a recess defined in a second wall, comprising:
a frame which includes (i) a first support having secured thereto a first hook member which has a first opening and a second hook member which has a second opening, said first hook member being (A) laterally spaced apart from said second hook member along a first axis which intersects a longitudinal axis of said first support and (B) positioned relative to said second hook member such that said first opening is in an opposing relationship with said second opening (ii) a second support positioned adjacent to said first support, said second support having secured thereto a third hook member which has a third opening and a fourth hook member which has a fourth opening, said third hook member being (A) laterally spaced apart from said fourth hook member along a second axis which intersects a longitudinal axis of said second support and (B) positioned relative to said fourth hook member such that said third opening is in an opposing relationship with said fourth opening and (iii) a cross bar which extends between said first support and said second support, said cross bar being secured to said first support and said second support; and
an axle which (i) has a transverse cross-section which has a shape of a parallelogram and (ii) has a unitary construction,
wherein when (i) said frame is positioned in a first orientation said first opening of said first hook member and said third opening of said third hook member are positioned to receive said first spindle and said second opening of said second hook member and said fourth opening of said fourth hook member are positioned to receive said axle for supporting said auxiliary rolled sheet material and (ii) when said frame is positioned in a second orientation said second opening of said second hook member and said fourth opening of said fourth hook member are positioned to receive said second spindle and said first opening of said first hook member and said third opening of said third hook member are positioned to receive said axle for supporting said auxiliary rolled sheet material.

9. The apparatus of claim 8, wherein:
said cross bar is secured to said first support such that a substantially 90° angle is defined between said cross bar and said first support.

10. The apparatus of claim 8, wherein:
a first end of said cross bar is attached to said first support at a first location which is interposed between said first hook member and said second hook member.

11. A method for hanging an auxiliary rolled sheet material from (i) a first spindle which is attached to an exterior surface of a first wall such that said first spindle is spaced outwardly from said exterior surface by a distance D₁ or (ii) a second spindle which is positioned within a recess defined in a second wall, comprising the steps of:
positioning a frame in a first orientation, said frame including (i) a first support having secured thereto a first hook member which has a first opening and a second hook member which has a second opening, said first hook member being (A) laterally spaced apart from said second hook member along a first axis which intersects a longitudinal axis of said first support and (B) positioned relative to said second hook member such that said first opening is in an opposing relationship with said second opening and (ii) a second support positioned adjacent to said first support, said second support having secured thereto a third hook member which has a third opening and a fourth hook member which has a fourth opening, said third hook member being (A) laterally spaced apart from said fourth hook member along a second axis which intersects a longitudinal axis of said second support and (B) positioned relative to said fourth hook member such that said third opening is in an opposing relationship with said fourth opening;
locating said frame relative to said first spindle so that said first spindle is positioned within said first hook member and said third hook member;
positioning said frame in a second orientation which is different from said first orientation; and
locating said frame relative to said second spindle so that said second spindle is positioned within said second hook member and said fourth hook member.

12. The method of claim 11, further comprising the steps of:
positioning an axle in said second hook member and said fourth hook member when said frame is positioned in said first orientation; and
positioning said axle in said first hook member and said third hook member when said frame is positioned in said second orientation.

13. The method of claim 12, further comprising the steps of:
disposing said auxiliary rolled sheet material around said axle positioned in said second hook member and said fourth hook member when said frame is positioned in said first orientation; and
disposing said auxiliary rolled sheet material around said axle positioned in said first hook member and said third hook member when said frame is positioned in said second orientation.

14. The method of claim 13, wherein said auxiliary rolled sheet material includes a removable sheet portion which is detachable from said auxiliary rolled sheet material, further comprising the step of:
removing said removable sheet portion from said auxiliary rolled sheet material; and
contacting a body portion of a user of said auxiliary rolled sheet material With said removable sheet portion.

15. The method of claim 12, wherein:
said axle has a transverse cross-section which has a shape of a parallelogram.

16. The method of claim 12, wherein:
said axle has a unitary construction.
